(19) United States
(12) Patent Application Publication
(10) Pub. No.: US 2026/0321025 A1
(43) Pub. Date: Oct. 15, 2026

(54) METHOD AND ELECTRONIC DEVICE FOR GENERATING OBJECT INFORMATION

(71) Applicants: HYUNDAI MOTOR COMPANY, Seoul (KR); KIA CORPORATION, Seoul (KR)

(72) Inventor: Jong Hyun CHOI, Hwaseong-si (KR)

(21) Appl. No.: 19/641,995

(22) Filed: Apr. 8, 2026

(30) Foreign Application Priority Data
Apr. 9, 2025 (KR) 10-2025-0045979

(51) Int. Cl. G06V 20/58; B60W 50/00; B60W 60/00; G06V 10/764; G06V 10/80; G06V 10/82; G06V 20/64; G06V 20/70

(52) U.S. Cl. CPC G06V 20/58; B60W 50/00; B60W 60/001; G06V 10/764; G06V 20/64; G06V 20/70; B60W 2050/0028; B60W 2556/40; G06V 10/817; G06V 10/82

(57) ABSTRACT

Disclosed herein a method and electronic device for generating object information. The method includes: generating, based on a plurality of local frame data including point cloud, a global map including the point cloud; generating a three-dimensional object map including three-dimensional semantic information on a global coordinate system, based on two-dimensional semantic segmentation information corresponding to key frame data selected through filtering of the local frame data; and generating object information based on the three-dimensional semantic information included in the three-dimensional object map.

### CROSS-REFERENCE TO RELATED APPLICATION

This application claims the benefit of priority to Korean Patent Application No. 10-2025-0045979, filed in the Korean Intellectual Property Office on Apr. 9, 2025, the disclosure of which is incorporated herein by reference in its entirety.

### TECHNICAL FIELD

The present disclosure relates to a method and electronic device for generating object information and relates to a method and electronic device for generating object information that provides object information accurate for learning or driving by generating three-dimensional object information and reduces a resource burden.

### BACKGROUND

The matters described in this Background section are only for enhancement of understanding of the background of the disclosure, and should not be taken as acknowledgment that they correspond to prior art already known to those skilled in the art.

Autonomous driving functions are being developed so that a vehicle may control its own driving while minimizing or completely excluding the intervention of a driver, and technologies supporting this are gradually being applied to the vehicle. In order to implement autonomous driving, the vehicle collects surrounding environment information through various types of heterogeneous sensors. Based on the data obtained from these sensors, the vehicle may perceive the surrounding environment and utilize the perceived information to identify the situation around the vehicle. A control plan for autonomous driving is established based on the identified situation, and through this, autonomous driving may be executed by controlling the driving device of the vehicle.

The autonomous driving may control the vehicle based on road condition information (e.g., road surface information, etc.), perceived from the sensor. Ground truth (GT) for perceiving road surface information used for autonomous driving may be mainly generated by utilizing 2D semantic segmentation or 2D keypoint. In this manner, since individual labeling is required for all image frames, hardware resources and generation costs required for data acquisition may be significant. In addition, the two-dimensional GT data may not accurately represent the coordinates of the three-dimensional space even if the learning is completed. For example, if the assumption on the ground is different from the actual environment, accurate recognition and control in a three-dimensional environment may not be implemented. This may hinder the stability and accuracy of autonomous driving.

### SUMMARY

A various examples of the present disclosure is to provide a method and electronic device for generating object information that provides object information accurate for learning or driving by generating three-dimensional object information and reduces a resource burden.

The various examples to be achieved in the present disclosure are not limited to the above-mentioned technical problems, and other technical problems not mentioned will be clearly understood by a person skilled in the art from the following description.

According to the present disclosure, a method performed by an apparatus for a vehicle may comprise obtaining, from the vehicle, a plurality of local frame data sets, wherein the plurality of local frame data sets may comprise point cloud data associated with a surrounding environment of the vehicle, generating, based on the plurality of local frame data sets, a global map that may comprise the point cloud data, selecting a key frame data set from the plurality of local frame data sets through filtering of the plurality of local frame data sets, determining, based on the key frame data set, two-dimensional semantic segmentation information, generating, based on the two-dimensional semantic segmentation information, a three-dimensional object map that may include three-dimensional semantic information on a global coordinate system, generating, based on the three-dimensional semantic information included in the three-dimensional object map, object information, training, using the object information, a learning model for autonomous driving of the vehicle, transmitting the trained learning model to the vehicle, and causing, via the transmitted trained learning model, autonomous driving control of the vehicle.

According to the present disclosure, a vehicle may comprise a plurality of sensors configured to obtain sensor data associated with a surrounding environment of the vehicle, a transceiver (e.g., a wireless transceiver and/or an in-vehicle transceiver, etc.) configured to transmit the sensor data to an electronic device (e.g., an internal device or an external device) and receive, from the electronic device, a learning model trained based on the sensor data for autonomous driving of the vehicle, a driving-control circuit configured to control autonomous driving of the vehicle, and a processor circuit configured to transmit, via the transceiver, at least a portion of the sensor data to the electronic device, wherein the transmission of the at least portion of the sensor data is configured to cause the electronic device to generate, based on the transmitted portion of the sensor data, a three-dimensional object map including three-dimensional semantic information on a global coordinate system and to train, based on the three-dimensional object map, a learning model for autonomous driving of the vehicle, to receive, via the transceiver, the trained learning model generated by the electronic device, to output, based on current sensor data obtained from the plurality of sensors and the trained learning model, a signal, and to control, through the driving-control circuit and based on the signal, autonomous driving of the vehicle.

The transmission of the portion of the sensor data may be configured to cause the electronic device to select a key-frame data set from a plurality of local frame data sets, wherein the plurality of local frame data sets are derived from the sensor data, and to determine, based on the key-frame data set, two-dimensional semantic-segmentation information. The transmission of the portion of the sensor data may be configured to cause the electronic device to process, based on the two-dimensional semantic-segmentation information, the three-dimensional object map to include the three-dimensional semantic information on the global coordinate system, to generate, based on the three-dimensional semantic information, object information associated with objects in the surrounding environment of the vehicle, and to train, using the object information, the learning model.

The processor circuit may be configured to receive, via the transceiver, an updated version of the trained learning model from the electronic device, to output, based on current sensor data obtained from the plurality of sensors and the updated version of the trained learning model, an updated signal, and to control, through the driving-control circuit and based on the updated signal, autonomous driving of the vehicle.

According to the present disclosure, an apparatus for a vehicle may comprise a processor and a memory storing at least one instruction that, when executed by the processor, is configured to cause the apparatus to obtain, from the vehicle, a plurality of local frame data sets, wherein the plurality of local frame data sets may comprise point cloud data associated with a surrounding environment of the vehicle, generate, based on the plurality of local frame data sets, a global map that may comprise the point cloud data, select a key frame data set from the plurality of local frame data sets through filtering of the plurality of local frame data sets, determine, based on the key frame data set, two-dimensional semantic segmentation information, generate, based on the two-dimensional semantic segmentation information, a three-dimensional object map including three-dimensional semantic information on a global coordinate system, generate, based on the three-dimensional semantic information, object information, train, using the object information, a learning model for autonomous driving of the vehicle, transmit the trained learning model to the vehicle, and cause, via the transmitted trained learning model, autonomous driving control of the vehicle.

The at least one instruction, when executed by the processor, may be configured to cause the apparatus to select, as the key frame data set, one local frame data set among the plurality of local frame data sets, wherein the one local frame data set satisfies a fitness condition and wherein the fitness condition is determined based on consistency between the global map and the one local frame data set. The at least one instruction, when executed by the processor, may be configured to cause the apparatus to obtain the two-dimensional semantic segmentation information by object recognition on associated image data corresponding to the key frame data set. The at least one instruction, when executed by the processor, may be configured to cause the apparatus to generate the two-dimensional semantic segmentation information, wherein the two-dimensional semantic segmentation information is associated with image data corresponding to the key frame data set, to project the key frame data set into the image data, to determine, based on the two-dimensional semantic segmentation information, an object class for each point associated with the key frame data set, and to process, based on the object class for each point, the three-dimensional object map to include the three-dimensional semantic information on the global coordinate system.

The key frame data set may comprise a plurality of data points based on an acquisition time of sensor data and a change in pose of at least one sensor of the vehicle, and the at least one instruction, when executed by the processor, may be configured to cause the apparatus to generate the three-dimensional object map based on a distribution of object classes accumulated in points of the plurality of data points for each voxel of the global map. The at least one instruction, when executed by the processor, may be configured to cause the apparatus to generate the three-dimensional semantic information by using a heat map indicating a probability distribution for each object class in the voxel. The at least one instruction, when executed by the processor, may be configured to cause the apparatus to generate, based on the three-dimensional semantic information, a keypoint corresponding to a vertex or edge of an object, wherein the vertex or edge is estimated from the three-dimensional semantic information, and wherein the keypoint is used in generating the object information. The at least one instruction, when executed by the processor, may be configured to cause the apparatus to generate, based on the three-dimensional object map, two-dimensional object representation information that may comprise three-dimensional position information.

The three-dimensional object map may be generated in a three-dimensional space defined by a voxel coordinate, the voxel coordinate comprising a first set of coordinates corresponding to a two-dimensional space used for generating the two-dimensional object representation information and a second coordinate along an axis different from coordinate axes of the first set of coordinates, and the at least one instruction, when executed by the processor, may be configured to cause the apparatus to determine the key frame data set, wherein the key frame data set may comprise the object information, to project the key frame data set into the two-dimensional space, to search for a value of the second coordinate in the voxel coordinate that minimizes a distance between a coordinate associated with the object information and a corresponding coordinate associated with the projected key frame data set in the two-dimensional space, and to generate, based on the searched value of the second coordinate and the coordinate associated with the object information, the two-dimensional object representation information comprising the three-dimensional position information.

The at least one instruction, when executed by the processor, may be configured to cause the apparatus to generate the global map using Simultaneous Localization and Mapping based on sensor data, wherein the sensor data is used to generate the point cloud data, and wherein the point cloud data represents objects in the surrounding environment.

The features briefly summarized above for this disclosure are only examples of the detailed description of the disclosure which follow and are not intended to limit the scope of the disclosure.

### BRIEF DESCRIPTION OF THE DRAWINGS

The above and other objects, features and advantages of the present disclosure will become more apparent to those of ordinary skill in the art by describing one or more example examples thereof in detail with reference to the accompanying drawings, in which:

FIG. 1 shows an example of modules configuring a device for generating object information.

FIG. 2 shows an example of a method of generating object information.

FIG. 3 is a diagram illustrating loop closing used to generate a global map.

FIG. 4 shows an example of three-dimensional object map generation.

FIG. 5 shows an example of the generation of a three-dimensional object map.

FIG. 6 shows an example of a keypoint of a three-dimensional object map.

FIG. 7 shows an example of a vehicle communicating with another device to transmit and receive data.

FIG. 8 shows an example of a module configuring a vehicle.

FIG. 9 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various different ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure. An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of generating consistent three-dimensional object information from sensor-image fusion) described herein, an operation of the vehicle may be controlled.

For example, when the processor determines that the fused three-dimensional object information obtained from LiDAR, radar, and image sensors exhibits high consistency (e.g., accurate spatial correlation and stable classification across multiple frames), the vehicle may autonomously maintain or increase its autonomous driving level, such as transitioning from partial to full lane-keeping control.

Conversely, when inconsistencies in fusion data are detected (e.g., mismatched object depth between LiDAR and image segmentation or fluctuating voxel classification probabilities), the processor may lower the autonomous driving level or issue a driver intervention request to ensure safety.

In another example, when consistent 3D fusion data indicates clear lane boundaries and free road space ahead, the control system may extend the prediction horizon for braking and acceleration control, thereby optimizing speed and comfort.

Alternatively, when fusion inconsistency suggests degraded visibility or ambiguous environmental features (e.g., snow, fog, or glare), braking time control and forward collision warning timing may be adjusted earlier to compensate for perception uncertainty.

Thus, by adapting autonomous driving control features according to the reliability of the fused three-dimensional object information, the vehicle can achieve stable, context-aware control across varying driving and environmental conditions.

One or more auxiliary devices (e.g., engine brake, exhaust brake, hydraulic retarder, electric retarder, regenerative brake, etc.) may also be controlled, for example, based on one or more features (e.g., feature of generating consistent three-dimensional object information from sensor-image fusion) described herein.

For instance, when the processor determines that the fused three-dimensional object information obtained from LiDAR and image sensors indicates a rapidly approaching obstacle with high consistency (e.g., stable object classification and distance estimation confidence above a threshold), the system may preemptively activate the engine brake or regenerative brake to decelerate the vehicle smoothly before engaging the primary braking system.

Conversely, when the fusion data reveals inconsistent or uncertain object recognition (e.g., blurred segmentation boundaries or irregular point cloud returns), the processor may reduce auxiliary braking torque to prevent unnecessary intervention or instability.

In another example, when consistent 3D fusion data indicates a downhill slope or curvature ahead (e.g., derived from voxel-based terrain gradient mapping), the exhaust brake or hydraulic retarder may be automatically activated to maintain vehicle stability and reduce reliance on service brakes.

Thus, auxiliary braking devices can be dynamically controlled based on the accuracy and reliability of the fused three-dimensional object information, improving braking efficiency, energy recovery, and overall safety during autonomous or semi-autonomous driving operations.

One or more communication devices (e.g., a modem, a network adapter, a radio transceiver, an antenna, etc.) that are capable of communicating via one or more wired or wireless communication protocols, such as Ethernet, Wi-Fi, near-field communication (NFC), Bluetooth, Long-Term Evolution (LTE), 5G New Radio (NR), or vehicle-to-everything (V2X), may also be controlled, for example, based on one or more features (e.g., feature of generating consistent three-dimensional object information from sensor-image fusion) described herein.

For example, when the processor determines that the consistency of fused three-dimensional object information between LiDAR depth data and image segmentation data is high (e.g., stable voxel confidence and accurate object localization), the communication device may reduce the frequency or bandwidth of external data transmission to conserve network resources.

Conversely, when inconsistencies are detected (e.g., degraded visibility or sensor interference causing uncertainty in object recognition), the communication device may automatically initiate or increase V2X communication to request supplemental map or perception data from nearby vehicles or infrastructure devices (e.g., an RSU or cloud server).

In another example, when a loss of consistency persists within a particular region (e.g., a tunnel, construction area, or urban canyon), the system may prioritize high-reliability communication channels such as 5G NR or DSRC to exchange environmental awareness data with surrounding vehicles.

Thus, by dynamically adjusting communication parameters based on the reliability of fused three-dimensional object information, the vehicle can maintain robust perception-sharing and network efficiency even under fluctuating sensing conditions.

Minimum risk maneuver (MRM) operation(s) may also be controlled, for example, based on one or more features (e.g., feature of generating consistent three-dimensional object information from sensor-image fusion) described herein.

A minimal risk maneuver operation may be initiated when the processor determines, based on fused three-dimensional object information, that environmental perception confidence has decreased below a threshold or that an unexpected obstacle exists within a predicted driving path.

For example, when inconsistencies are detected between LiDAR-based depth data and image-based segmentation data (e.g., sudden disparity in obstacle distance or shape recognition), the system may recognize degraded perception reliability and activate a minimum risk maneuver, such as gradual deceleration and controlled steering toward a road shoulder or emergency lane.

In another example, when consistent three-dimensional object information identifies a stationary obstacle (e.g., a stalled vehicle or barrier) ahead with high probability and low relative motion, the MRM control may execute an early stop maneuver while maintaining lateral distance from nearby dynamic objects.

Alternatively, if the fusion result indicates occluded regions with uncertain classification (e.g., low voxel confidence around cross traffic or pedestrians), the system may reduce speed, flash hazard lights, and prepare for a controlled halt to reach a minimum-risk state.

By utilizing consistency and reliability of the fused three-dimensional object information as a trigger or modifier for MRM activation, the vehicle can perform safe fallback maneuvers even under sensor degradation, environmental uncertainty, or driver unavailability.

Biased driving operation(s) may also be controlled, for example, based on one or more features (e.g., feature of generating consistent three-dimensional object information from sensor-image fusion) described herein. A driving control apparatus may determine a biased lateral driving position of the vehicle in a lane according to three-dimensional object information that is fused from LiDAR-based depth data and camera-based image segmentation data.

For example, when the fused three-dimensional object map indicates that an obstacle (e.g., a truck, guardrail, or construction cone) is detected near one side of the lane boundary with high consistency across multiple frames, the vehicle may adjust its biased lateral position toward the opposite side of the lane to increase clearance.

Conversely, when the fusion result indicates that one side of the road provides greater drivable space or smoother surface geometry (e.g., based on consistent voxel elevation data and semantic segmentation of the road surface), the system may bias the vehicle toward that region to enhance ride stability.

In another example, when the processor determines that the confidence of object detection on one side drops below a threshold (e.g., due to occlusion or rain-induced LiDAR noise), the vehicle may temporarily shift its biased position away from that uncertain region to reduce collision risk.

Accordingly, by using the consistency of the fused three-dimensional object information as a control parameter, the driving control apparatus can dynamically determine or update a biased target lateral distance to improve safety, comfort, and reliability of autonomous lane-keeping and lane-change maneuvers under varying environmental conditions.

One or more sensors (e.g., IMU sensors, cameras, LiDAR, radar, blind-spot monitoring sensors, line-departure warning sensors, parking sensors, light sensors, rain sensors, traction control sensors, anti-lock braking system sensors, tire pressure monitoring sensors, seatbelt sensors, and the like) may also be controlled, for example, based on one or more features (e.g., feature of generating consistent three-dimensional object information from sensor-image fusion) described herein.

For instance, when the processor determines that fused three-dimensional object information derived from LiDAR depth data and image-based segmentation is consistent and stable (e.g., uniform voxel classification confidence and accurate depth alignment), sensor operation parameters such as sampling frequency or detection range may be automatically optimized to conserve energy and computation resources.

Conversely, when inconsistency is detected (e.g., a sudden mismatch between radar and camera detections, or reduced image-LiDAR correspondence due to heavy rain, fog, or low illumination), specific sensors such as LiDAR or radar may be reactivated at higher resolution or longer range to enhance environmental awareness.

In another example, when the fusion system identifies occluded or unclassified regions in the three-dimensional map (e.g., due to a blind corner or dynamic object movement), auxiliary sensors such as side cameras or ultrasonic sensors may be prioritized or reoriented to re-scan the affected area.

Through such adaptive control of sensors based on the reliability of fused three-dimensional object information, the vehicle can maintain stable perception performance while reducing redundant sensing and computational load during autonomous driving.

An autonomous driving level and/or autonomous driving activation/deactivation may also be controlled, for example, based on one or more features (e.g., feature of generating consistent three-dimensional object information from sensor-image fusion) described herein.

A driving control apparatus may adjust an autonomous driving level (e.g., change a control mode, modify a required user attentiveness, etc.) or deactivate autonomous driving according to the accuracy and reliability of fused three-dimensional object information.

For example, when the processor determines that the consistency between LiDAR-based depth data and image-based segmentation data decreases below a threshold (e.g., due to rain, fog, or poor illumination), the autonomous driving level may be automatically lowered from full autonomous mode to semi-autonomous mode to prompt driver intervention.

Alternatively, when the system detects highly consistent three-dimensional object information (e.g., stable voxel-based classification confidence across multiple frames), the vehicle may autonomously resume a higher driving level, such as full lane-keeping or adaptive cruise control.

In another example, when an occlusion or sensor degradation causes uncertainty in the fused object map (e.g., loss of keypoints or mismatched depth values), the system may temporarily deactivate autonomous control and issue a driver takeover alert.

By dynamically controlling the autonomous driving level based on the reliability of the fused three-dimensional object information, the vehicle can maintain safer operation while optimizing user attentiveness requirements and energy consumption.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

According to the present disclosure, a method and electronic device may generate accurate three-dimensional (3D) object information for autonomous driving while reducing data-generation costs. Image data from cameras and 3D point-cloud data from a lidar sensor may be combined to create a global 3D map through simultaneous localization and mapping (SLAM). Based on key frames, the device may generate a 3D object map containing semantic information for each voxel and extract key points on objects such as lanes, road markers, or guardrails. The key points may then be projected into two-dimensional (2D) images to produce 2D object representation information that links image pixels with 3D spatial coordinates. The generated data may serve as training ground truth for object recognition or autonomous driving control, providing high spatial accuracy with reduced labeling effort.

Hereinafter, examples of the present disclosure will be described with reference to the accompanying drawings.

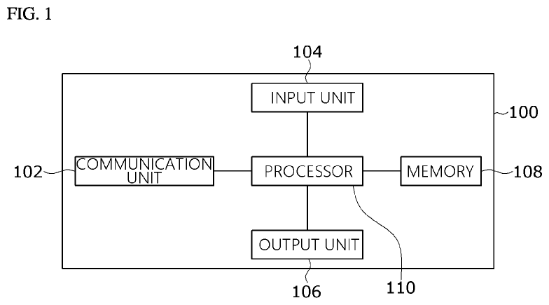

Hereinafter, an electronic device that performs a method for generating object information according to an example of the present disclosure will be described with reference to FIG. 1. FIG. 1 shows an example of modules configuring a device for generating object information according to an example of the present disclosure.

Referring to FIG. 1, an electronic device 100 may generate a three-dimensional object map including three-dimensional semantic information based on image data of an image sensor and three-dimensional sensor data of a three-dimensional recognition sensor different from the image sensor. The three-dimensional object map may be generated in a three-dimensional space that provides the absolute position of an object (e.g., a road sign, pedestrian, building façade, or roadside vegetation, etc.). The three-dimensional object map may be generated, for example, in a world coordinate system space. The three-dimensional semantic information includes, but is not limited to, probability data of object class and object estimation for each voxel of the three-dimensional space, and may have various data (e.g., confidence values, category labels, or motion vectors, etc.).

In addition, the electronic device 100 may generate two-dimensional object representation information including three-dimensional position information based on the three-dimensional object map. The two-dimensional object representation information may be included in, for example, image data represented in a two-dimensional space (e.g., RGB image, infrared frame, or depth map, etc.). The two-dimensional object representation information may include, for example, keypoints, data associated with certain points of an object for a particular purpose (e.g., feature matching, tracking, or pose estimation, etc.).

The keypoint may be a marker generated on a vertex or edge of an object recognized in the image data using an object recognition model (e.g., a convolutional neural network, transformer-based detector, or feature-point extractor, etc.). The keypoint is not only described as a two-dimensional space of image data but may be generated to include three-dimensional position information. The three-dimensional position information may include coordinates described in a two-dimensional space of the image data and a coordinate associated with a depth (or height) in the image data. An object marked with a keypoint may include, for example, a road marker on a road surface, a road facility installed on the road, a structure in the vicinity of the marker and the road facility, and the like (e.g., traffic signs, pedestrian crossings, or streetlights, etc.). The road marker may include, for example, a driving direction indicator (e.g., a directional arrow) printed on the road, a lane, a parking line in a parking lot, and the like. The roadway facility may be, for example, a central divider, a guardrail, a traffic cone/bar, etc., and the structure may be, for instance, a post in the vicinity of a parking line, etc.

In addition, the electronic device 100 may train a learning model related to autonomous driving by using the image data including the two-dimensional object representation information as training ground truth and inputting the training image data (e.g., annotated frames, segmented images, or labeled sensor fusion data, etc.). The learning model may be, for example, a network associated with object detection, semantic segmentation, depth information, and object-aware end-to-end autonomous driving. The electronic device 100 distributes the trained image-based learning model to another device, for example, a vehicle (200, 400 in FIG. 7; hereinafter, denoted as 200 for convenience of description), so that the vehicle 200 may utilize the distributed image-based learning model for controlling the vehicle, for example, controlling a driving or parking operation (e.g., lane-keeping, obstacle avoidance, or automated valet parking, etc.).

In addition, the image sensor and the three-dimensional recognition sensor may be mounted on a device for acquiring training data. A plurality of image sensors may be mounted at multiple sites of the device (e.g., front bumper, side mirror, or rear trunk, etc.). Accordingly, the image data utilized in the generation of the object information may relate to a surrounding environment obtained as a two-dimensional image from the plurality of image sensors. The device may be a movable device, such as a vehicle, a robot, or the like (e.g., a delivery robot, unmanned ground vehicle, or aerial drone, etc.). As another example, the device may be provided in the electronic device 100 having mobility.

The three-dimensional recognition sensor is a sensor different from the image sensor and may output three-dimensional sensor data that three-dimensionally recognizes the environment around the device. The three-dimensional sensor data may output, for example, a point set that three-dimensionally obtains an object of the surrounding environment (e.g., trees, pedestrians, traffic lights, or nearby vehicles, etc.). The point set may be a point cloud including a plurality of mutually spaced points for detecting an object. In this disclosure, the point cloud may be referred to as point cloud data. Here, the point may be configured in a form such as a dot or a short length line (e.g., pixel-level 3D coordinate, laser return pulse, or dense depth pixel, etc.). The three-dimensional recognition sensor may include, for example, at least one of a lidar sensor, a radar sensor or an ultrasonic sensor (e.g., time-of-flight lidar, millimeter-wave radar, or sonar module, etc.). In the present disclosure, for convenience of description, the three-dimensional recognition sensor is described by taking a lidar sensor as an example.

On the other hand, a vehicle 200 that receives at least one of the two-dimensional object representation information or the learning model from the electronic device 100 may refer to a device that may move. The vehicle 200 is a ground vehicle driving on the ground, and may be a conventional passenger or commercial vehicle, a Purpose Built Vehicle (PBV), or the like (e.g., taxi, delivery van, or bus, etc.). The vehicle 200 may be a robot in a broad sense, such as a moving means, and the robot may be moved using wheels, tracks, or other moving modules (e.g., hover module, crawler belt, or omni-wheel, etc.). The vehicle 200 may be driven autonomously or passively.

The autonomous vehicle 200 may be implemented as semi-autonomous driving or fully autonomous driving. The fully autonomous driving may be provided as an autonomous movement in which the vehicle 200 completely controls without user intervention, even if the driving situation is uncertain (e.g., in dense traffic, fog, or low-light environments, etc.). The semi-autonomous driving may be provided in an autonomous movement in which driver intervention is required depending on a specific driving situation (e.g., complex intersections, unpaved roads, or emergency maneuvers, etc.).

The learning model trained using the two-dimensional object representation information according to the present disclosure as training ground truth is not only applied to the vehicle 200 for ground driving, but may be applied to various transportation devices such as, for example, a flight mobility device, a water mobility device for water transportation, or an underwater mobility device (e.g., drone, boat, or a submarine, etc.).

The electronic device 100 may be, for example, a device, such as a server, provided separately from the vehicle 200 to be operated by a vehicle manufacturer or operated by a management agency that services autonomous driving (e.g., a cloud-based fleet management system, a traffic control center, or a mobility-as-a-service platform, etc.). When the electronic device 100 is a vehicle manufacturer that supports autonomous driving or a server operated in a management period, connected data of the vehicle 200 may be received, or data necessary for autonomous driving may be transmitted. The electronic device 100 may transmit various information and software modules used for control of the vehicle 200 to the vehicle 200 in response to requests and data transmitted from the vehicle 200 and a user device, to support autonomous driving of the vehicle 200 and various services. In the present disclosure, functions of the electronic device 100 related to the learning method according to the example will be mainly described.

The electronic device 100 may include a communication unit 102, an input unit 104, an output unit 106, a memory 108, and a processor 110.

The communication unit 102 may support mutual communication with the vehicles 200 and 400, an ITS device 300, and the like. In the present disclosure, the communication unit 102 may be a communication interface that generates a three-dimensional object map having object information, two-dimensional object representation information, and receives various data and software used to train a learning model (e.g., CAN-bus messages, V2X packets, or cloud dataset uploads, etc.). The received data may include heterogeneous sensor data, such as lidar data and image data, that have detected at least the same environment (e.g., synchronized timestamped lidar frames and camera images, etc.). The communication interface may transmit the map, the information, and the learning model to the vehicle 200. In the present disclosure, the learning model may be referred to as a network, a learning network, or a model.

In addition, the communication unit 102 may be a communication module that receives data generated or stored during driving from the vehicle 200 and transmits information supporting driving, such as map information, environment information for recognizing objects around the vehicle 200, traffic information, weather information, and the like (e.g., road construction alerts, accident notifications, lane-change guidance, or real-time navigation updates, etc.), to the vehicle 200. The communication unit 102 may be a communication module that transmits an application associated with a driving and convenience function (e.g., parking assistance, infotainment control, or over-the-air (OTA) updates, etc.).

The input unit 104 may include an interface to receive a user's request (e.g., a touchscreen, microphone, or gesture-recognition sensor, etc.), and the output unit 106 may include an interface that visually provides information generated in accordance with the present disclosure (e.g., a display panel, head-up display (HUD), or speaker output, etc.). The information may include, for example, a three-dimensional object map including object information, image data including two-dimensional object representation information, results derived from a learning model during training, and data related to a trained learning model (e.g., accuracy metrics, confusion matrices, or model weights, etc.).

The memory 108 may store a program for controlling the electronic device 100 and various data and load the program or read and write the data at the request of the processor 110.

In the present disclosure, the memory 108 may hold image data, lidar data, and an object recognition model provided to generate object information and two-dimensional object representation information of a three-dimensional object map (e.g., datasets of captured road scenes, labeled point clouds, or annotated video sequences, etc.). The object recognition model may include a two-dimensional semantic segmentation model and a keypoint generation model using a learning model (e.g., a convolutional neural network (CNN), transformer-based vision network, or hybrid encoder-decoder architecture, etc.), e.g., using image data as an input. The keypoint generation model may be, for example, a model that generates a three-dimensional keypoint from a three-dimensional object map or generates a two-dimensional keypoint based on image data. In the present disclosure, the memory 108 may hold software that generates object information and two-dimensional object representation information and an autonomous driving model for training using the information.

In addition to the data described above, the memory 108 may also hold applications for implementing driving and convenience functions of the vehicle 200, map information, traffic information, weather information, and other various information affecting driving (e.g., road elevation maps, fuel efficiency data, charging station locations, or driver-behavior analytics, etc.).

The processor 110 may perform overall control of the electronic device 100. The processor 110 may be configured to execute applications and instructions stored in the memory 108. Specifically, the processor 110 may execute processing of generating a global map configured with a point cloud, based on a plurality of local frame data configured with the point cloud (e.g., fusing lidar frames collected over time to construct a global environmental model, etc.). The processor 110 may perform processing of generating a three-dimensional object map including globally three-dimensional semantic information, based on two-dimensional semantic segmentation information corresponding to key frame data selected through filtering of local frame data (e.g., selecting representative lidar frames with high alignment accuracy or temporal stability, etc.). In addition, the processor 110 may execute processing of generating object information in the three-dimensional object map, based on the three-dimensional semantic information (e.g., labeling each voxel as a car, pedestrian, road, or tree, etc.). The processor 110 may implement processing of generating two-dimensional object representation information including three-dimensional position information based on the three-dimensional object map (e.g., projecting 3D bounding boxes or keypoints into camera image coordinates, etc.). With such processing, a two-dimensional object perceived by a predetermined model in the two-dimensional image data may be labeled with the two-dimensional object representation information. The two-dimensional object representation information is, for example, a keypoint, which may be labeled with three-dimensional positional information (e.g., (x, y, z) coordinates derived from depth estimation or 3D reconstruction, etc.).

Then, the processor 110 may train a learning model for autonomous driving by using image data and image data labeled with the two-dimensional object representation information as training data (e.g., pairs of RGB images and semantic annotations, synthetic datasets, or sensor-fused training samples, etc.). A detailed description of the above-described processes by the processor 110 will be described later.

In addition, the processor 110 may perform processing that supports driving and convenience functions of the vehicle 200 (e.g., adaptive cruise control, automatic emergency braking, lane-keeping assist, or intelligent parking assist, etc.). In the present disclosure, the processor 110 may be implemented as, for example, a single processing module (e.g., a system-on-chip (SoC), embedded GPU, or neural processing unit (NPU), etc.). As another example, the processing according to the above-described matters may be distributed processing in a plurality of processing modules, and the processor 110 may be collectively referred to as a plurality of the processing modules in this disclosure (e.g., a main CPU for logic control and a dedicated AI accelerator for neural inference, etc.).

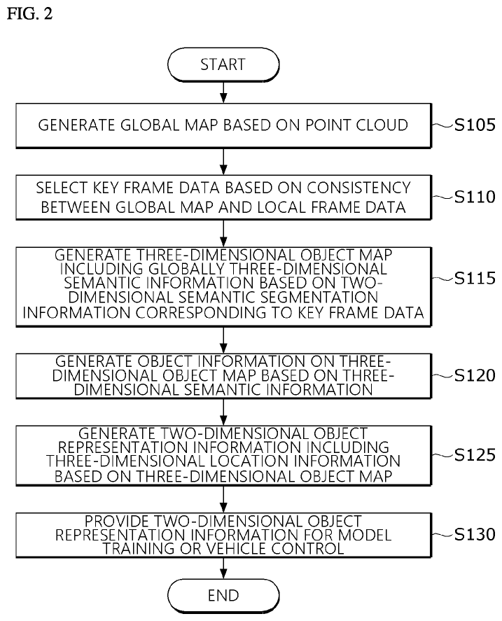

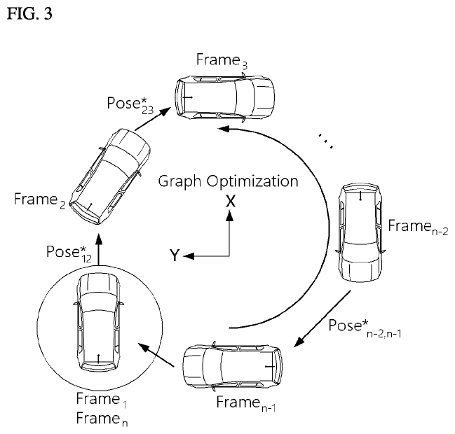

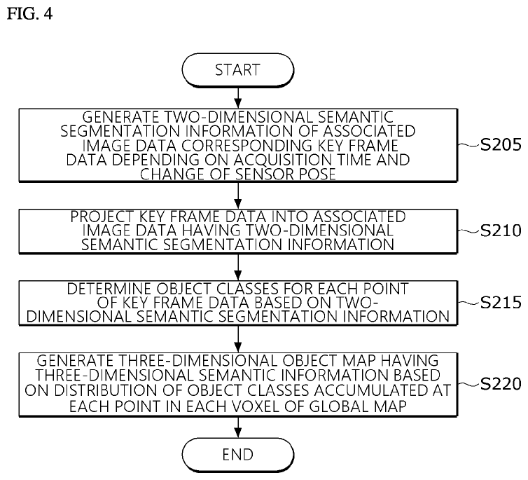

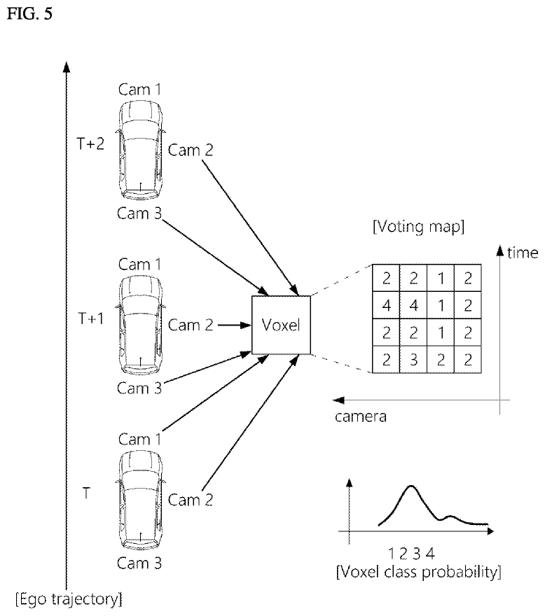

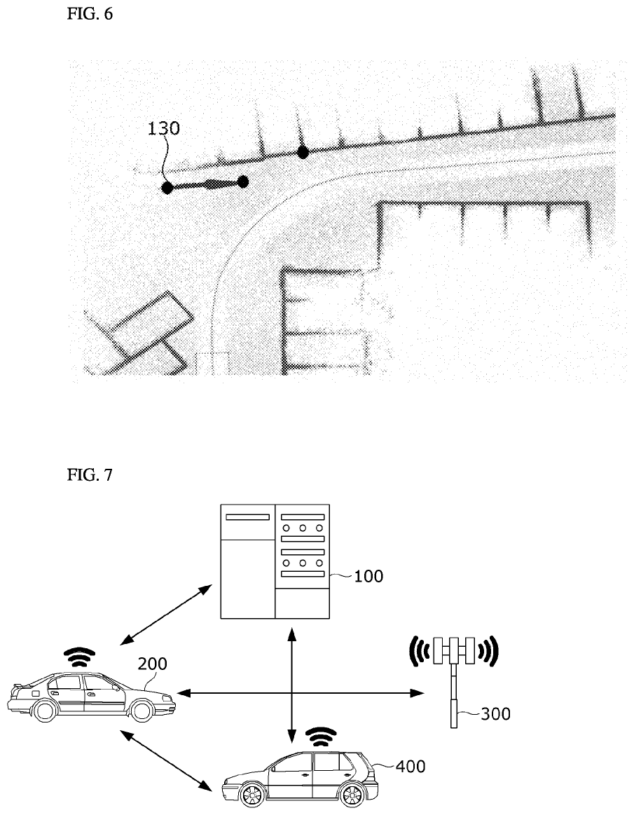

Hereinafter, a method for generating object information according to another example of the present disclosure will be described in detail with reference to FIG. 2, FIG. 3, FIG. 4, FIG. 5, and FIG. 6. FIG. 2 shows an example of a method of generating object information according to another example of the present disclosure.

Although the present disclosure mainly describes that image data in which a three-dimensional object map including object information and two-dimensional object representation information according to an example are labeled is mainly generated only in the electronic device 100, a generation method described below may be processed in a distributed manner in the electronic device 100 and other devices without conflicting with the following description. Other devices may be, for example, other servers and/or vehicles 200, 400 (e.g., a cloud computing server, an edge processing unit, or a local vehicle-mounted processor, etc.). Hereinafter, the processor 110 of the electronic device 100 may be abbreviated as the electronic device 100 for convenience of description, or these terms may be used interchangeably.

Referring to S105 of FIG. 2, the processor 110 of the electronic device 100 may generate a global map including point cloud based on a plurality of local frame data acquired from a lidar sensor that detects an object as a point cloud (e.g., buildings, trees, road surfaces, pedestrians, or traffic cones, etc.).

The processor 110 may generate a global map using Simultaneous Localization and Mapping (SLAM) based on sensor data of a lidar that provides an object to a point cloud. The SLAM may include a plurality of processes (e.g., iterative closest point (ICP), loop detection, loop closing, or pose graph optimization, etc.). The processor 110 may generate, by the processes described above, a global map based on lidar data in a three-dimensional space that provides an object to an absolute location (e.g., a world coordinate system aligned with GPS or IMU reference, etc.). The three-dimensional space may be, for example, a space employing a world coordinate system.

The sensor data of the lidar may include a plurality of local frame data obtained based on an acquisition time and a change in pose of the lidar sensor due to movement of the vehicle (e.g., translation, rotation, or pitch/roll changes during driving, etc.). The ICP estimates a lidar odometry between two adjacent local frame data, and the lidar odometry is the same as the behavior of the vehicle, so that the driving path of the vehicle 200 may be estimated. Specifically, the ICP may receive vehicle behavior information (e.g., a CAN signal, IMU sensor data, or wheel odometer reading, etc.) and a signal of the lidar sensor to estimate the behavior of the vehicle between the local frame data.

The loop detection may determine whether the vehicle has returned to the same location based on the ICP between the local frame data Frame₁ of the start time and the local frame data Frameₙ of the subsequent time, as illustrated in FIG. 3. FIG. 3 is a diagram illustrating loop closing used to generate a global map. The loop detection may determine whether the ICP result between the first local frame data and the target local frame data is close to the identity range. The loop detection may optimize the behavior graph of the vehicle based on the loop, as illustrated in FIG. 3, to estimate the vehicle attitude graph throughout the sequence based on the entire local frame data (e.g., by correcting accumulated drift or alignment error across long driving trajectories, etc.).

When a loop is detected, the loop closing may establish the following equation Pose₁, =Pose_{1,2}*Pose_{2,3} . . . Pose_{n-2,n-1}*Pose_{n-1,n}=Identity (same). The loop closing may perform graph optimization utilizing the above equation to generate an optimized pose graph Pose*, as illustrated in FIG. 3 (e.g., through back-end optimization using Gauss-Newton or Levenberg-Marquardt algorithms, etc.).

The processor 110 may accumulate, by the SLAM, a point cloud of each local frame data to generate a lidar-based global map. Specifically, the processor 110 may generate the global map Mn up to the n-th local frame data by accumulating the pose (or behavior) information Pose* optimized for each local frame data through the above-described process, as shown in Equation 1 below. According to an example of the following equation (1), the first local frame data may be a reference of the world coordinate system (e.g., a fixed origin at the initial lidar scan or GPS reference, etc.).

$${M}_{n} = {\sum }_{i = 1}^{n} ( {Pose}_{1 , i} * {L}_{i} ) \qquad [ Equation 1 ]$$

Referring back to S110 of FIG. 2, the processor 110 may select local frame data that is determined to have the fitness of key frame data based on the consistency between the global map and the local frame data. S110 may filter a plurality of local frame data by the consistency and adopt the filtered local frame data as key frame data (e.g., selecting representative frames with minimal motion distortion or high overlap regions, etc.).

The Pose* of the local frame data may have an error due to an error caused by ICP and optimization, so that the local frame data of the error is not consistent with the global map and thus may be removed from the global map (e.g., discarding scans captured during sudden acceleration, wheel slip, or sensor misalignment, etc.).

The processor 110 may use an equation of the suitability score, e.g., Equation (2) below, to select key frame data for the local frame data to be finally included in the global map.

$${fitness}_{i} = 1 - MSE ( I ( 4 ) - ICP ( {L}_{i} , {pose}_{1 , i}^{- 1} ( {M}_{k ∈ 1 ∼ i - 1 , i + 1 ∼ n} ) ) ) \qquad [ Equation 2 ]$$

Here, Lᵢ is the i-th local frame data, and ICP may be related to the distance or behavior difference between the i-th local frame data Lᵢ and the accumulated lidar map (or lidar-based map) M_{k∈1~i-1,i+1~n} excluding the Lᵢ in the world coordinate system. I(4) is a 4×4 unit matrix, and MSE may be a function of obtaining the difference between two data sets as a mean square error (e.g., used to evaluate alignment error between corresponding points in overlapping scans, etc.).

Each local frame data is obtained in the space of the same world coordinate system, so that the value of the ICP may, in principle, be substantially the same as the unit matrix I. The MSE is an index for quantitatively measuring the magnitude of the error, and the processor 110 may identify a difference between the unit matrix I(4) and the ICP result to evaluate the error of the consistency. The smaller the difference, the better the local frame data Lᵢ may be consistent with the global map.

When an error occurs in ICP and loop closing, an error between Mₖ and Lᵢ is caused, so that the ICP result between the two may be shifted away from the unit matrix I. Using this property, the fitness score according to Equation 2 may be closer to 1 as it approaches the unit matrix I (e.g., indicating nearly perfect registration between the scan and the reference map, etc.).

The processor 110 may select the local frame data whose fitness score meets the consistency condition according to Equation 3 as key frame data and update the global map to configure the global map based on the key frame data. According to the example of Equation (3), only local frame data with a fitness score greater than 0.98 may be selected as key frame data (e.g., rejecting scans with large localization drift or misalignment, etc.).

$${M}_{n} = {\sum }_{i = 1}^{n} ( {Pose}_{1 , i} * {L}_{i} ) , if {fitness}_{i} > 0.98 \qquad [ Equation 3 ]$$

Referring to S115 of FIG. 5, the processor 110 of the electronic device 100 may generate a three-dimensional object map including globally three-dimensional semantic information, based on two-dimensional semantic segmentation information corresponding to the key frame data.

The two-dimensional semantic segmentation information may be acquired by object recognition on associated image data corresponding to the key frame data (e.g., color camera images, fisheye camera views, or stereo image pairs, etc.). The processor 110 loads image data that matches a time range including, for example, an acquisition time of key frame data from the memory 108 and the loaded image data in the present disclosure may be referred to as associated image data. The processor 110 may generate two-dimensional coordinates of the associated image data, that is, object classes, probability data of object estimation, and other data for each pixel, by using a learning model that performs semantic segmentation (e.g., a deep convolutional network such as SegNet, DeepLab, or Mask R-CNN, etc.). The object class, probability data, and other data for each pixel may constitute two-dimensional semantic segmentation information (e.g., pixel-level labels indicating “road,” “vehicle,” “pedestrian,” or “building,” etc.).

Referring to FIG. 4, the generation of the three-dimensional object map in relation to S115 will be described in detail. FIG. 4 shows an example of three-dimensional object map generation.

Referring to S205 of FIG. 4, the processor 110 may generate two-dimensional semantic segmentation information of associated image data corresponding to key frame data. The key frame data may include a plurality of data depending on a change in an acquisition time of sensor data of the lidar and a change in pose of the lidar sensor. The change in pose may include a change in the position of the sensor based on the movement of the vehicle and a change in the direction of view (or imaging) at the sensor with the movement (e.g., tilt, yaw, or pitch variation of the lidar sensor during cornering or elevation change, etc.). The two-dimensional semantic segmentation information is generated for each pixel of the associated image data corresponding to each key frame data, and detailed descriptions thereof will be omitted as they are described above.

Referring to S210 of FIG. 4, the processor 110 may project the key frame data into associated image data having the two-dimensional semantic segmentation information. The projection may be processed by performing position transformation and rotation on the key frame data (e.g., coordinate transformation, homogeneous matrix multiplication, or extrinsic parameter-based projection, etc.), e.g., using geometric parameters of the key frame data and geometric parameters of the associated image data. The geometry parameter of each data may be an internal geometry parameter and an external geometry parameter. The internal geometric parameter of each data may be a parameter based on a unique attribute of each sensor (e.g., focal length, principal point, or lens distortion coefficient, etc.), and the external geometric parameter of each data may be a parameter related to the pose of the sensor based on the movement of the vehicle (e.g., sensor mounting position, roll-pitch-yaw orientation, or vehicle coordinate transformation, etc.). The pose of the sensor may include a position of the sensor and a direction of the sensor.

Referring to S215 of FIG. 4, the processor 110 may determine, based on the two-dimensional semantic segmentation information, the object classes for each point of the key frame data (e.g., vehicle, pedestrian, traffic sign, or road surface, etc.).

Referring to S220 of FIG. 4, the processor 110 may generate a three-dimensional object map to have three-dimensional semantic information, based on a distribution of the object classes accumulated at points of a plurality of key frame data, for each voxel of the global map (e.g., assigning probabilities of “road,” “curb,” or “building” to each voxel, etc.).

FIG. 5 shows an example of the generation of a three-dimensional object map. The processor 110 may describe object classes 1 to 4 for each point of the key frame data by referring to the two-dimensional semantic segmentation information of the associated image data corresponding to each acquisition time and pose of the respective key frame data. As illustrated in FIG. 5, the processor 110 may generate three-dimensional semantic information by using a heat map indicating a probability distribution for each object class in a voxel (e.g., visualized as color intensities representing confidence of road, vehicle, or tree detection, etc.). FIG. 5 illustrates that a voting map is a heat map having different colors for each object class or probability of the object class. In FIG. 5, the object class 2 has a higher probability distribution than the other classes, so that the color of the object class 2 mixed with the other classes may dominate in the voxel. Accordingly, the global three-dimensional object map may be generated such that the voxel has three-dimensional semantic information that is estimated to be object class 2 according to the probability distribution.

Referring to S220 related to FIG. 5 in more detail, the two-dimensional semantic segmentation information may be accumulated by, for example, a product of the number of image sensors and the acquisition time with respect to the world coordinate system (e.g., data fusion from multiple front, side, and rear cameras over sequential frames, etc.). Accordingly, semantic information in voxels on the global map may be present as much as the product of the number of image sensors capable of observing the voxels and the number of observations. The voxel is, for example, a voxel showing a road surface (e.g., asphalt, crosswalk, or shoulder area, etc.). At this time, when a histogram in which observation information for each class is accumulated is generated, semantic information of the road surface may appear as a probability distribution. In the present disclosure, an object class of a voxel on a specific road surface is not designated as a single representative value, and a distribution for each class may be represented in the voxel (e.g., road surface 70%, sidewalk 25%, curb 5%, etc.).

When the above description is executed on the point cloud of all the key frame data accumulated in advance, for all the road surfaces on the world coordinate system, a heat map indicating a probability distribution for each object class of voxels on each road surface may be generated. The brighter the heat map is in a particular object class, the higher the probability that the voxel has the semantic information (e.g., bright red for “vehicle,” green for “tree,” or blue for “road,” etc.).

Accordingly, the three-dimensional object map may be generated to have globally three-dimensional semantic information, based on an object class per point of the key frame data. Here, the global three-dimensional object map is generated by a combination of all key frame data, such as the global maps in S105 and S110, and may be provided on a global coordinate system having the same three-dimensional space as the global map. In detail, the three-dimensional object map may be generated in a three-dimensional space with voxel coordinates (e.g., a 3D grid with cell sizes of 0.1-0.5 m, etc.). Thus, the three-dimensional object map may be formed to represent three-dimensional semantic information on a global coordinate system.

Referring again to S120 of FIG. 2, the processor 110 of the electronic device 100 may generate object information in the three-dimensional object map, based on the three-dimensional semantic information.

The object information may be a keypoint 130 generated based on a vertex or edge estimated from three-dimensional semantic information globally arranged in a three-dimensional object map, as illustrated in FIG. 6. Here, the keypoint may be a three-dimensional marker having three-dimensional position information (e.g., a corner of a traffic sign, the tip of a guardrail, or a curb edge, etc.). FIG. 6 shows an example of a keypoint of a three-dimensional object map.

The three-dimensional keypoint may be generated on the vertex or edge of markers/traffic facilities on the road surface that are recognized in the three-dimensional semantic information (e.g., lane markings, bollards, or barriers, etc.), for example, using a keypoint detection model. The keypoint may be a marker or a three-dimensional marker labeled on a traffic facility. The object information is not limited to a keypoint and may be data related to a certain point of an object for a specific purpose (e.g., centroid of a detected object, point of interest for tracking, or surface normal vector, etc.).

Referring to S125 of FIG. 2, the processor 110 may generate two-dimensional object representation information including three-dimensional position information based on the three-dimensional object map.

The two-dimensional object representation information may be labeled to an object recognized in the associated image data (e.g., vehicle silhouette, pedestrian outline, or lane marking boundary, etc.). The two-dimensional object representation information that is labeled on the object may be, for example, a keypoint or data associated with a certain point of the object for a particular purpose (e.g., pose estimation, tracking, or behavior prediction, etc.). The two-dimensional object representation information may be generated based on the object information and provided to have three-dimensional position information of the object in the associated image data. The three-dimensional position information may include two-dimensional coordinates of the associated image data and a coordinate related to the depth or height of the object information. Here, the voxel coordinates of the three-dimensional object map representing the depth of the object information may include first coordinates (x, y) converted into coordinates of a two-dimensional space providing the two-dimensional object representation information and a second coordinate (z) in a coordinate axis having a direction different from coordinate axes of the first coordinates. The depth-related coordinates of the three-dimensional position information may be generated based on the second coordinate (e.g., representing vertical displacement, elevation, or range distance, etc.).

Describing a process of generating two-dimensional object representation information, the processor 110 may determine key frame data including object information of a three-dimensional global map. The processor 110 may project the determined key frame data into a two-dimensional space of image data (e.g., overlaying the 3D keypoints onto camera frames for visualization or labeling, etc.). The projection may be performed using, for example, geometric parameters of the key frame data and geometric parameters of the image data (e.g., intrinsic matrices, extrinsic transforms, or rectification parameters, etc.). The processor 110 may search for second coordinates of the key frame data that minimize the distance between the object coordinates of the object information and the projected key frame data in the two-dimensional space (e.g., using least-squares or gradient-based optimization, etc.). The processor 110 may generate the two-dimensional object representation information including three-dimensional position information, based on the searched second coordinate and the object coordinate.

More specifically, the three-dimensional object map and the pose (Pose1,i) for each key frame data are pre-computed, so that the processor 110 may project the object information, for example, the key point, of the three-dimensional object map into the image data via the following equation (4).

$$( {u}_{i} , {ν}_{i} ) = W 2 {I}_{cam} ( {Pose}_{1 , i}^{- 1} ( x , y , z ) ) \qquad [ Equation 4 ]$$

Here, (x, y, z) are coordinates of a three-dimensional global map, and W2Icam may mean projecting to an image sensor in a world coordinate system.

x,y in Equation (4) may be generated on the world coordinate system, but the z value may differ depending on the observation time of the object, so that a plurality of z values may exist in a single voxel. Accordingly, a z value to be applied to the image data may be selected from a plurality of values. To this end, the processor 110 may select the key frame data having the highest suitability score among the key frame data in which the key point of the image data appears, based on the suitability score according to Equation (2), and optimize the z value of the key point of the three-dimensional global map from the selected frame data via Equation (5) below. At this time, the target keypoint may be selected by the user (e.g., manual annotation or region-of-interest selection, etc.), or may be selected by utilizing a 2D keypoint detection model. As another example, the optimal value of the keypoint is determined by a binary search-based ternary search, and is not limited thereto, and may be determined in various manners (e.g., gradient descent, iterative refinement, or probabilistic optimization, etc.).

$$arg {min}_{z} ( {\sum }_{cam = 1}^{10} ( ( u , v ) - W 2 {I}_{cam} ( {Pose}_{1 , i}^{- 1} ( x , y , z ) ) ) \qquad [ Equation 5 ]$$

Here, (u, v) are two-dimensional coordinates of image data, (x, y, z) are coordinates of a three-dimensional global map, and W2Icam may mean projecting to an image sensor in a world coordinate system. Equation (5), described in argmin, may represent searching for a second coordinate of key frame data that minimizes the distance between the object coordinates of the object information and the projected key frame data in the two-dimensional space.

The above-described manner is different from the labeling manner for each image data, and when object information such as a keypoint is formed on the three-dimensional global map, all data may be formed in all frames constituting the three-dimensional global map (e.g., enabling temporal consistency across sequential frames, etc.). The generated object information may be generated not only in a keypoint form, but also in various forms such as an occupancy grid map and a polygon (e.g., semantic mesh, boundary contour, or surface patch, etc.).

Referring to S130 of FIG. 2, the processor 110 may be provided for training of a learning model that uses image data having the two-dimensional object representation information as ground truth or may provide for vehicle control through the communication unit 102 (e.g., autonomous driving decision, path planning, or adaptive control feedback, etc.).

According to the present disclosure, object information accurate for learning or driving is provided by generating three-dimensional object information, and resource burden and cost required for generating the object information may be reduced (e.g., less manual labeling time, fewer on-road data collection passes, or reduced cloud compute usage, etc.).

In addition, according to the present disclosure, it is possible to generate a three-dimensional global map based on data obtained in a vehicle and generate road surface information data as a three-dimensional keypoint on the map. When a three-dimensional keypoint is labeled as a single operation on a three-dimensional global map, the three-dimensional keypoint may be utilized as reference data or ground truth in image data acquired by driving on the map (e.g., for lane boundary alignment, curb detection, or parking slot localization, etc.). In addition, the information having the three-dimensional spatial coordinates of the road surface globally in the three-dimensional global map is utilized in the construction of a deep learning model for detecting the recognition logic of the road surface information, for example, the load marker keypoint, and the spatial information accuracy may be very excellent as compared with the image ground truth having the two-dimensional information (e.g., fewer projection errors, tighter reprojection residuals, or improved pose estimation stability, etc.). In addition, unlike labels for each image data, the spatial coordinates of the road surface may be consistently maintained throughout the three-dimensional object map (e.g., across frames, routes, or weather conditions, etc.).

The vehicle 200 that receives two-dimensional object representation information generated in FIG. 2 or a learning model trained using the information from the electronic device 100 and another device that communicates with the electronic device 100 will be described.

FIG. 7 shows an example of a vehicle communicating with another device to transmit and receive data.

The vehicle 200 may refer to a device capable of moving to a particular point, as described above. Although the vehicle 200 is described as an example of a vehicle driving on the ground in the present disclosure, the present disclosure may also be applied to a mobility device for flight or water traffic (e.g., UAV, surface vessel, or underwater ROV, etc.). As described above with reference to FIG. 1, the vehicle 200 may be autonomously controlled and driven, and autonomous driving may be implemented as semi-autonomous driving or fully autonomous driving.

The vehicle 200 may be driven on an electrical energy or fossil energy basis. In the case of electric energy, the vehicle 200 may employ, for example, a pure battery-based vehicle driven only by a high-voltage battery or a gas-based fuel cell as an energy source (e.g., hydrogen, ammonia, compressed natural gas, etc.). Further, the fuel cell may utilize various types of gases capable of generating electrical energy, and the gas may be hydrogen, for example. However, various gases are applicable without being limited thereto. In the case of fossil energy, the vehicle 200 may be driven based on a fuel, such as gasoline, diesel, or liquefied gas, and may be equipped with an engine that drives the wheels included in an actuator 214 by combustion of the fuel. The engine may be included in a power source unit 212 in terms of providing a drive rotational force of the wheel to the actuator 214. Alternatively, the vehicle 200 may be driven in a hybrid manner of electric energy and fossil energy (e.g., series hybrid, parallel hybrid, or plug-in hybrid, etc.).

On the other hand, the vehicle 200 may perform communication with other devices 100, 300 or another vehicle 400. Other devices may include, for example, the electronic device 100 that supports various controls, state management, and driving of the vehicle 200, an ITS device 300 for receiving information from an ITS, various types of user devices, and the like (e.g., smartphones, roadside units, or cloud servers, etc.). As described above with reference to FIG. 1, the electronic device 100 may be, for example, an external device operated by a vehicle manufacturer or operated by a management agency that services autonomous driving (e.g., fleet operations center, mobility service provider, or map service backend, etc.).

The ITS device 300 is, for example, a roadside base station (RSU), and the ITS device 300 may interchange vehicle recognition data, driving control and state data, environment data around the vehicle, map data, and the like through V2I with the vehicle 200 to assist the user's driving of the vehicle or support autonomous driving of the vehicle 200 (e.g., signal phase and timing (SPaT), MAP messages, or hazard alerts, etc.). The vehicle 200 may support manual driving or autonomous driving by interchanging the above-listed data through V2V with the other vehicle 400 (e.g., cooperative lane change, platooning, or collision avoidance, etc.).

The vehicle 200 may communicate with other vehicles or other devices based on cellular communication, Wireless Access in Vehicular Environment (WAVE) communication, Dedicated Short Range Communication (DSRC) or near field communication, or other communication schemes (e.g., C-V2X PC5/Uu, Wi-Fi, or Bluetooth LE, etc.).

For example, the vehicle 200 may use a communication network such as LTE or 5G, a Wi-Fi communication network, a WAVE communication network, or the like as a cellular communication network for communication with the electronic device 100, the ITS device 300, or the other vehicle 400. As another example, a DSRC or the like used in the vehicle 200 may be used for communication between vehicles. A communication manner between the vehicle 200, the electronic device 100, the ITS device 300, another vehicle 400, and a user device is not limited to the foregoing example (e.g., satellite links or mesh networking, etc.).

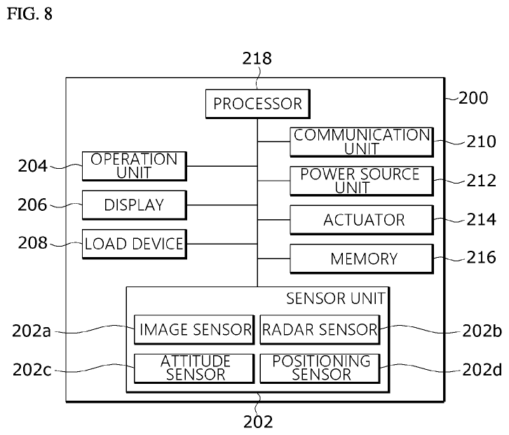

FIG. 8 shows an example of modules that configure the vehicle according to the present disclosure.

The vehicle 200 may include a sensor unit 202, an operation unit 204, a display 206, a load device 208, and a communication unit 210.

The sensor unit 202 may include various types of sensors for sensing various states and situations occurring in an external surrounding environment, an internal system, a user operation, and a boarding space of the vehicle 200 (e.g., cameras, lidar, radar, IMU, GNSS, cabin monitors, or tire pressure sensors, etc.).

Specifically, the sensor unit 202 may include an externally-oriented image sensor 202a, a radar sensor 202b, and the like to recognize dynamic and static objects existing around the vehicle 200 (e.g., vehicles, pedestrians, cyclists, or road signs, etc.).

The image sensor 202a may recognize an external object as an image during use of the vehicle 200, generate image data, and transmit the image data to the processor 218. The image sensor 202a may be mounted on a specific site of the vehicle 200, such as a front site, a rear site, and a side site of the vehicle 200 (e.g., grille, tailgate, or side mirror housing, etc.). When a plurality of image sensors 202a are mounted on each site, it may be referred to as a multi-camera in the present disclosure. The image data acquired by the plurality of image sensors 202a may be referred to as multi-view image data or multi-view.

The radar sensor 202b may emit radio waves of a specific frequency around the vehicle 200 to generate radar data through the radio waves reflected from the external object in order to detect the presence and relative distance, speed, direction, and the like of the external object (e.g., range-Doppler measurements, azimuth angle, or object tracks, etc.). Although the present disclosure illustrates that a lidar sensor (not shown) is not mounted, in another example, the lidar sensor may be mounted on the vehicle 200 (e.g., roof-mounted, grille-integrated, or pillar-mounted lidar, etc.).

The sensor unit 202 may include an attitude sensor 202c. The attitude sensor 202c may detect, for example, states of three axes of the vehicle 200, such as yaw, pitch, and roll, and output various pose states of the vehicle based on the factors described above. The attitude sensor may be configured, for example, as an IMU sensor, a gyro sensor, or the like (e.g., 6-axis IMU, wheel encoder fusion, or visual-inertial odometry, etc.). The processor 218 may generate pose data based on the pose state.

In addition, the sensor unit 202 may include a positioning sensor 202d for confirming the position of the vehicle 200. The positioning sensor 202d is, for example, but not limited to, a GPS sensor or a GNSS sensor (e.g., RTK-GNSS or PPP corrections, etc.).

The present disclosure mainly describes the sensors of the sensor unit 202, which are referred to in the description, and may further include sensors that sense various situations not listed therein (e.g., ultrasonic sensors, rain/light sensors, or driver monitoring cameras, etc.).

The operation unit 204 may be configured as a module for a user to steer for driving. For example, the operation unit 204 may be a steering wheel for manual driving, an automatic or manual transmission actuator, an accelerator pedal, a brake pedal, a gear transmission, or the like (e.g., turn-signal stalks, drive-mode switches, or ADAS enable buttons, etc.). The operation unit 204 may further include an interface for using, releasing, and selecting a detailed function of the autonomous driving mode requested from the user, so that the user uses the autonomous driving function (e.g., engage/disengage, lane change confirm, or parking mode selection, etc.).

The display 206 may serve as a user interface. The display 206 may be displayed by the processor 218 to output an operation state of the vehicle 200, a control state, route/traffic information, remaining energy information, or content requested by the driver, and the like (e.g., navigation maps, AD status, alerts, or infotainment, etc.). In addition, the display 206 may be configured as a touch screen on which driver input is detectable to receive a driver's request instructing the processor 218 (e.g., pinch-zoom map, tap-to-confirm lane change, or destination entry, etc.).

The load device 208 is mounted on the vehicle 200 and may be a type of non-driving electric device excluding a driving power system such as a wheel drive unit (not shown). The load device 208 is an auxiliary device that receives power from the power source unit 212, and may be, for example, an air conditioning system, an indicator lamp system, an illumination system, a seat system, and various devices installed in the vehicle 200 (e.g., windows, audio, or cabin sensors, etc.).

The communication unit 210 may support mutual communication with the server 100, the ITS device 300, the surrounding vehicle 400 and the like. The communication unit 210 may include, for example, a module that processes cellular communication, WAVE, DSRC communication, and the like. In the present disclosure, the communication unit 210 may transmit data generated or stored during driving to the server 100 and receive data and a software module transmitted from the server 100 (e.g., OTA model updates, HD map tiles, or diagnostics, etc.). The communication unit 210 may support communication for transmitting or receiving signals related to data, control, commands, and requests between the components of FIG. 8. The components may be instruments or modules referred to as reference numerals 202-218 illustrated in FIG. 8. The communication unit 110 may transmit a signal transmitted between components, that is, a signal related to data, control, command, and request, to a communication bus by using, for example, controller area network (CAN) communication, and transmit the signal to a specific component (e.g., LIN, FlexRay, or Ethernet AVB, etc.). Data, controls, commands, and requests conveyed in CAN communication may be referred to as CAN data. The communication unit 210 may support communication with an electronic device carried by a passenger inside the vehicle 200 (e.g., smartphone pairing, Wi-Fi hotspot, or Bluetooth audio, etc.).

In addition, the vehicle 200 may include the power source unit 212 and the actuator 214.

The power source unit 212 may generate and supply power and electric power to be used for a driving power system and a non-driving power system such as the actuator 214. The non-driving power system may be, for example, and not limited to, the sensor unit 202, the operation unit 204, the display 206, the load device 208, the communication unit 210, and the like, and may include various components that implement sensing, interface, communication, and convenience functions except for components directly involved in driving operations (e.g., cabin HVAC, lighting, or infotainment, etc.).

The actuator 214 includes at least one module that implements a driving operation and may execute the driving operation based on a user request from the operation unit 204 or a signal according to a request of the processor 218. The signal according to the request may be associated with at least one of a longitudinal control such as acceleration or deceleration, a lateral control such as steering, or a gear shift, for example (e.g., speed hold, lane centering, or automated parking, etc.). Here, the gear shift may be processed at the request of a manual driving user using a gear shifter or by the processor 218 in autonomous driving.

The actuator 214 may include a wheel drive unit (not shown), and a mechanical component and an electronic module for implementing a driving operation in the wheel drive unit to perform a driving operation according to a command of the processor 218 by a user's manual operation or autonomous driving. When the vehicle 200 is operated on an electrical energy basis, it may include an assembly for transmitting the requested driving motion to the wheel drive unit 118 (e.g., inverter, reduction gear, or e-axle, etc.). When the vehicle 200 is operated on a fossil energy basis, the actuator 214 may include a transmission and gear module that transmits the power of the internal combustion engine (e.g., automatic transmission, DCT, or CVT, etc.).

The wheel drive unit may include a plurality of wheels, a driving force generation module for generating a driving force and applying or transmitting the driving force to the wheels, a braking module for decelerating driving of the wheels, and a steering module for realizing lateral control of the wheels. When the vehicle 200 is driven on an electrical energy basis, the driving force generation module may be configured with a motor assembly that generates a driving force on the basis of power output from an electrical battery. The braking module of the electric-based vehicle 200 may further have a regenerative braking function (e.g., blended braking or one-pedal driving, etc.).

In addition, the vehicle 200 may include a memory 216 and the processor 218.

The memory 216 may store applications and various data for control of the vehicle 200 to load the applications or read and write the data at the request of the processor 218 (e.g., model parameters, HD maps, or calibration files, etc.). In the present disclosure, the memory 216 may receive and manage the parameters of the image sensor 202a from the server 100 (e.g., intrinsics, extrinsic, or distortion models, etc.). In addition, the memory 216 may receive and manage information necessary for driving, such as map information, traffic information, weather information, accident information, and the like (e.g., road closures, speed limits, or precipitation forecasts, etc.).

The processor 218 may perform overall control of the vehicle 200. The processor 218 may be configured to execute applications and instructions stored in the memory 216. Specifically, the processor 218 may use the image processing network corresponding to the learning model to recognize the object and estimate the state information of the object based on the image data and the two-dimensional object representation information acquired from the image sensor 202a. The image processing learning network may be a network utilized for vehicle control or vehicle driving, for example, an object detection model, a semantic segmentation model, a depth estimation model, or the like (e.g., YOLO, DeepLab, MonoDepth, or BEV fusion, etc.). The processor 218 may control the driving based on the estimated state information of the object (e.g., adjust speed, modify path, or issue a braking command, etc.). In addition, the processor 218 may perform autonomous driving control based on information estimated from the image, along with various data recognized from the radar sensor 202b, the attitude sensor 202c and the positioning sensor 202d (e.g., sensor fusion for perception, localization, and planning, etc.).

In the present disclosure, the processor 218 may be implemented as a single processing module, as an example. As another example, the processing according to the foregoing may be distributed processing in a plurality of processing modules, and the processor 218 may be collectively referred to as a plurality of the processing modules in this disclosure (e.g., main CPU, GPU/AI accelerator, and microcontrollers for real-time control, etc.).

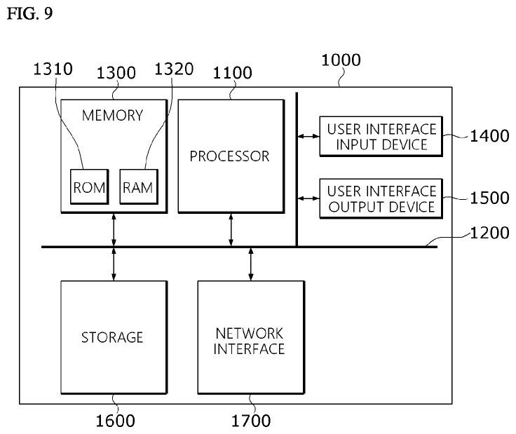

FIG. 9 shows an example computing system (e.g., a computing device of a vehicle or any other apparatus). One or more controllers, processors, etc. described herein, such as one or more components of the electronic device 100 or vehicle 200, or any other components and devices disclosed herein, may be implemented by or in the computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, there is provided method for generating object information, the method comprising: generating, based on a plurality of local frame data including point cloud, a global map including the point cloud; generating a three-dimensional object map including three-dimensional semantic information on a global coordinate system, based on two-dimensional semantic segmentation information corresponding to key frame data selected through filtering of the local frame data; and generating object information based on the three-dimensional semantic information included in the three-dimensional object map.

For examples, the filtering may comprise selecting the local frame data that is determined to have a fitness of the key frame data based on the consistency between the global map and the local frame data.

For examples, the two-dimensional semantic segmentation information may be acquired by object recognition on associated image data corresponding to the key frame data.

For examples, the generating a three-dimensional object map may comprise: generating two-dimensional semantic segmentation information of associated image data corresponding to the key frame data; projecting the key frame data into associated image data having the two-dimensional semantic segmentation information; determining an object class for each point of the key frame data, based on the two-dimensional semantic segmentation information; and generating, based on the object class per point, the three-dimensional object map to have the three-dimensional semantic information on the global coordinate system.

For examples, the key frame data may comprise a plurality of data depending on an acquisition time of sensor data and a change in pose of a sensor; and the generating a three-dimensional object map may comprise generating the three-dimensional object map, based on the distribution of the object class accumulated in points of the plurality of key frame data, for each voxel of the global map.

For examples, the generating a three-dimensional object map may include generating the three-dimensional semantic information by using a heat map indicating a probability distribution for each object class in the voxel.

For examples, the generating object information may include generating a keypoint at a vertex or edge estimated from the three-dimensional semantic information.

For examples, the method may further comprise generating two-dimensional object representation information including three-dimensional position information based on the three-dimensional object map.

For examples, the three-dimensional object map may be generated in a three-dimensional space having a voxel coordinate, the voxel coordinate including first coordinates converted into coordinates of the two-dimensional space providing the two-dimensional object representation information and a second coordinate in a coordinate axis having a direction different from coordinate axes of the first coordinates. Also, the generating two-dimensional object representation information may comprise: determining key frame data including the object information; projecting the determined key frame data into the two-dimensional space; searching for the second coordinate of the key frame data that minimizes a distance between object coordinate of the object information and the projected key frame data in the two-dimensional space; and generating, based on the searched second coordinate and the object coordinate, the two-dimensional object representation information including the three-dimensional position information.

For examples, the generating a global map may include generating the global map using Simultaneous Localization and Mapping (SLAM) based on sensor data that provides an object to the point cloud.

According to another example of the present disclosure, there is provided an electronic device for generating object information, the electronic device comprising: a memory storing at least one instruction; and at least one processor executing the at least one instruction stored in the memory. The at least one processor is configured to: generate, based on a plurality of local frame data including point cloud, a global map including the point cloud; generate a three-dimensional object map including three-dimensional semantic information on a global coordinate system, based on two-dimensional semantic segmentation information corresponding to key frame data selected through filtering of the local frame data; and generate object information based on the three-dimensional semantic information included in the three-dimensional object map.

According to the present disclosure, a method and electronic device for generating object information are provided, which provides object information accurate for learning or driving by generating three-dimensional object information and reduce a resource burden.

The effects obtainable in the present disclosure are not limited to the effects mentioned above, and other effects not explicitly mentioned will be apparent to a person skilled in the art from the following description.

While the exemplary methods of the present disclosure described above are represented as a series of operations for clarity of description, it is not intended to limit the order in which the steps are performed, and the steps may be performed simultaneously or in a different order as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in any combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general-purpose processors, controllers, microcontrollers, or microprocessors, etc.

The scope of the disclosure includes software or machine-executable commands (e.g., an operating system, an application, firmware, a program, etc.) for enabling operations according to the methods of various examples to be executed on an apparatus or a computer, and a non-transitory computer-readable medium having such software, commands, or instructions stored thereon and executable on the apparatus or the computer.

What is claimed is:

1. A method performed by an apparatus for a vehicle, the method comprising:
obtaining, from the vehicle, a plurality of local frame data sets, wherein the plurality of local frame data sets comprise point cloud data associated with a surrounding environment of the vehicle;
generating, based on the plurality of local frame data sets, a global map comprising the point cloud data;
selecting a key frame data set from the plurality of local frame data sets through filtering of the plurality of local frame data sets;
determining, based on the key frame data set, two-dimensional semantic segmentation information;
generating, based on the two-dimensional semantic segmentation information, a three-dimensional object map including three-dimensional semantic information on a global coordinate system;
generating, based on the three-dimensional semantic information included in the three-dimensional object map, object information;
training, using the object information, a learning model for autonomous driving of the vehicle;
transmitting the trained learning model to the vehicle; and
causing, via the transmitted trained learning model, autonomous driving control of the vehicle.

2. The method of claim 1, wherein the selecting of the key frame data set comprises
selecting, as the key frame data set, one local frame data set among the plurality of local frame data sets, wherein the one local frame data set satisfies a fitness condition, and wherein the fitness condition is determined based on consistency between the global map and the one local frame data set.

3. The method of claim 1, further comprising:
obtaining the two-dimensional semantic segmentation information by object recognition on associated image data corresponding to the key frame data set.

4. The method of claim 1, wherein the generating of the three-dimensional object map comprises:
generating the two-dimensional semantic segmentation information, wherein the two-dimensional semantic segmentation information is associated with image data corresponding to the key frame data set;
projecting the key frame data set into the image data;
based on the two-dimensional semantic segmentation information, determining an object class for each point associated with the key frame data set; and
processing, based on the object class for each point, the three-dimensional object map to include the three-dimensional semantic information on the global coordinate system.

5. The method of claim 4, wherein the key frame data set comprises a plurality of data points based on an acquisition time of sensor data and a change in pose of at least one sensor of the vehicle associated with the plurality of local frame data sets; and
wherein the generating of the three-dimensional object map comprises generating the three-dimensional object map, based on a distribution of object classes accumulated in points of the plurality of data points for each voxel of the global map.

6. The method of claim 5, wherein the generating of the three-dimensional object map comprises generating the three-dimensional semantic information by using a heat map indicating a probability distribution for each object class in the voxel.

7. A vehicle comprising:
a plurality of sensors configured to obtain sensor data associated with a surrounding environment of the vehicle;
a transceiver configured to transmit the sensor data to an electronic device and receive, from the electronic device, a learning model trained based on the sensor data for autonomous driving of the vehicle;
a driving-control circuit configured to control autonomous driving of the vehicle; and
a processor circuit configured to:
transmit, via the transceiver, at least a portion of the sensor data to the electronic device, wherein the transmission of the at least portion of the sensor data is configured to cause the electronic device to:
generate, based on the transmitted portion of the sensor data, a three-dimensional (3D) object map including 3D semantic information on a global coordinate system, and
train, based on the 3D object map, a learning model for autonomous driving of the vehicle,
receive, via the transceiver, the trained learning model generated by the electronic device,
output, based on current sensor data obtained from the plurality of sensors and the trained learning model, a signal, and
control, through the driving-control circuit and based on the signal, autonomous driving of the vehicle.

8. The vehicle of claim 7, wherein the transmission of the portion of the sensor data is configured to cause the electronic device to:
select a key-frame data set from a plurality of local frame data sets, wherein the plurality of local frame data sets are derived from the sensor data, and
determine, based on the key-frame data set, two-dimensional (2D) semantic-segmentation information.

9. The vehicle of claim 8, wherein the transmission of the portion of the sensor data is configured to cause the electronic device to:
process, based on the 2D semantic-segmentation information, the 3D object map to include the 3D semantic information on the global coordinate system,
generate, based on the 3D semantic information, object information associated with objects in the surrounding environment of the vehicle, and
train, using the object information, the learning model.

10. The vehicle of claim 7, wherein the processor circuit is further configured to:
receive, via the transceiver, an updated version of the trained learning model from the electronic device,
output, based on current sensor data obtained from the plurality of sensors and the updated version of the trained learning model, an updated signal, and
control, through the driving-control circuit and based on the updated signal, autonomous driving of the vehicle.

11. An apparatus for a vehicle, the apparatus comprising:
a processor; and
a memory storing at least one instruction that, when executed by the processor, is configured to cause the apparatus to:
obtain, from the vehicle, a plurality of local frame data sets, wherein the plurality of local frame data sets comprise point cloud data associated with a surrounding environment of the vehicle,
generate, based on the plurality of local frame data sets, a global map comprising the point cloud data,
select a key frame data set from the plurality of local frame data sets through filtering of the plurality of local frame data sets,
determine, based on the key frame data set, two-dimensional semantic segmentation information,
generate, based on the two-dimensional semantic segmentation information, a three-dimensional object map including three-dimensional semantic information on a global coordinate system,
generate, based on the three-dimensional semantic information, object information,
train, using the object information, a learning model for autonomous driving of the vehicle,
transmit the trained learning model to the vehicle, and
cause, via the transmitted trained learning model, autonomous driving control of the vehicle.

12. The apparatus of claim 11, wherein the at least one instruction, when executed by the processor, is configured to cause the apparatus to select, as the key frame data set, one local frame data set among the plurality of local frame data sets, wherein the one local frame data set satisfies a fitness condition, and wherein the fitness condition is determined based on consistency between the global map and the one local frame data set.

13. The apparatus of claim 11, wherein the at least one instruction, when executed by the processor, is configured to cause the apparatus to obtain the two-dimensional semantic segmentation information by object recognition on associated image data corresponding to the key frame data set.

14. The apparatus of claim 11, wherein the at least one instruction, when executed by the processor, is configured to cause the apparatus to:
generate the two-dimensional semantic segmentation information, wherein the two-dimensional semantic segmentation information is associated with image data corresponding to the key frame data set,
project the key frame data set into the image data,
based on the two-dimensional semantic segmentation information, determine an object class for each point associated with the key frame data set, and
process, based on the object class for each point, the three-dimensional object map to include the three-dimensional semantic information on the global coordinate system.

15. The apparatus of claim 14, wherein the key frame data set comprises a plurality of data points based on an acquisition time of sensor data and a change in pose of at least one sensor of the vehicle, and wherein the at least one instruction, when executed by the processor, is configured to cause the apparatus to generate the three-dimensional object map, based on a distribution of object classes accumulated in points of the plurality of data points for each voxel of the global map.

16. The apparatus of claim 15, wherein the at least one instruction, when executed by the processor, is configured to cause the apparatus to generate the three-dimensional semantic information by using a heat map indicating a probability distribution for each object class in the voxel.

17. The apparatus of claim 11, wherein the at least one instruction, when executed by the processor, is configured to cause the apparatus to generate, based on the three-dimensional semantic information, a keypoint corresponding to a vertex or edge of an object, wherein the vertex or edge is estimated from the three-dimensional semantic information, and wherein the keypoint is used in generating the object information.

18. The apparatus of claim 11, wherein the at least one instruction, when executed by the processor, is configured to cause the apparatus
to generate, based on the three-dimensional object map, two-dimensional object representation information comprising three-dimensional position information.

19. The apparatus of claim 18,
wherein the three-dimensional object map is generated in a three-dimensional space defined by a voxel coordinate, the voxel coordinate comprising:
a first set of coordinates corresponding to a two-dimensional space used for generating the two-dimensional object representation information, and
a second coordinate along an axis different from coordinate axes of the first set of coordinates, and
wherein the at least one instruction, when executed by the processor, is configured to cause the apparatus to:
determine the key frame data set, wherein the key frame data set comprises the object information;
project the key frame data set into the two-dimensional space;
search for a value of the second coordinate in the voxel coordinate that minimizes a distance between a coordinate associated with the object information and a corresponding coordinate associated with the projected key frame data set in the two-dimensional space; and
generate, based on the searched value of the second coordinate and the coordinate associated with the object information, the two-dimensional object representation information comprising the three-dimensional position information.

20. The apparatus of claim 11, wherein the at least one instruction, when executed by the processor, is configured to cause the apparatus to generate the global map using Simultaneous Localization and Mapping (SLAM) based on sensor data, wherein the sensor data is used to generate the point cloud data, and wherein the point cloud data represents objects in the surrounding environment.
